(19) United States
(12) Patent Application Publication
(10) Pub. No.: US 2018/0088213 A1
(43) Pub. Date: Mar. 29, 2018

(54) DISTANCE MEASURING DEVICE

(71) Applicant: TOPCON CORPORATION, Tokyo (JP)

(72) Inventors: Hideki MORITA, Tokyo (JP); Ken' ichiro YOSHINO, Tokyo (JP)

(73) Assignee: TOPCON CORPORATION, Tokyo (JP)

(21) Appl. No.: 15/711,299

(22) Filed: Sep. 21, 2017

(30) Foreign Application Priority Data
Sep. 28, 2016 (JP) 2016-189547

(51) Int. Cl. G01S 7/484; G01S 17/10

(52) U.S. Cl. CPC G01S 7/484; G01S 17/10

(57) ABSTRACT

A technique for decreasing attenuation of emitted pulsed light with a pulse width of 2 ns or less is provided. A light emitting circuit configured to emit pulsed light includes a boosting block, a laser diode, a wiring, a charge capacitor with its end connected to the wiring, and a switching element configured to be turned on or off to apply voltage to the laser diode. The inductance of the wiring is not greater than 1.4 nH. The laser diode emits pulsed light with a pulse width of 2 ns or less.

### CROSS-REFERENCE TO RELATED APPLICATION

This application is based upon and claims the benefit of priority from Japanese Patent Application No. 2016-189547, filed Sep. 28, 2016, the entire contents of which are incorporated herein by reference.

### BACKGROUND OF THE INVENTION

### Technical Field

The present invention relates to a circuit for emitting pulsed light.

### Background Art

Distance measuring devices using pulses of light are publicly known. FIG. 1 shows a circuit of a light emitting part for measuring a distance using pulses of light (refer to Japanese Unexamined Patent Application Laid-Open No. 2010-139295). This type of circuit typically emits light with a pulse width of approximately 10 ns. A distance measuring device using this circuit tends to have laser interference due to unnecessary internal reflection in its main structure, thereby increasing deviation of distance measurement values. For this reason, an optical mechanism should be provided to the main structure to avoid the interference, resulting in increase in production cost of the main structure and hindering size reduction.

Making light with a pulse width of 2 ns or less be emitted prevents the laser interference and enables distance measurement with high accuracy, without using the optical mechanism for avoiding the laser interference. This method provides distance measuring with high accuracy and enables an inexpensive product configuration by reducing the size of the main structure and reducing the number of parts (refer to Japanese Patent No. 3169082).

### SUMMARY OF THE INVENTION

When an attempt is made to emit pulsed light with a pulse width of 2 ns or less using the circuit shown in FIG. 1, frequency characteristics are deteriorated due to the effect of inductance of a wiring pattern of the circuit, and it is difficult to emit pulsed light with the pulse width of 2 ns or less. An object of the present invention is to provide a technique for enabling emission of pulsed light with a pulse width of 2 ns or less.

A first aspect of the present invention provides a circuit configured to emit pulsed light, and the circuit includes a voltage generating circuit, a light emitting element, a circuit wiring that connects the voltage generating circuit and the light emitting element, a charge capacitor with its end connected to the circuit wiring, and a switching element configured to be turned on or off to apply voltage to the light emitting element. The inductance of the circuit wiring is not greater than 1.4 nH. The light emitting element emits pulsed light with a pulse width of 2 ns or less.

The present invention provides a technique for enabling emission of pulsed light with a pulse width of 2 ns or less.

### BRIEF DESCRIPTION OF DRAWINGS

FIG. 1 is a circuit diagram of a conventional art.

FIG. 2 is a circuit diagram using the present invention.

FIG. 3 is a graph showing a relationship between frequency and attenuation value in each wiring having a different inductance.

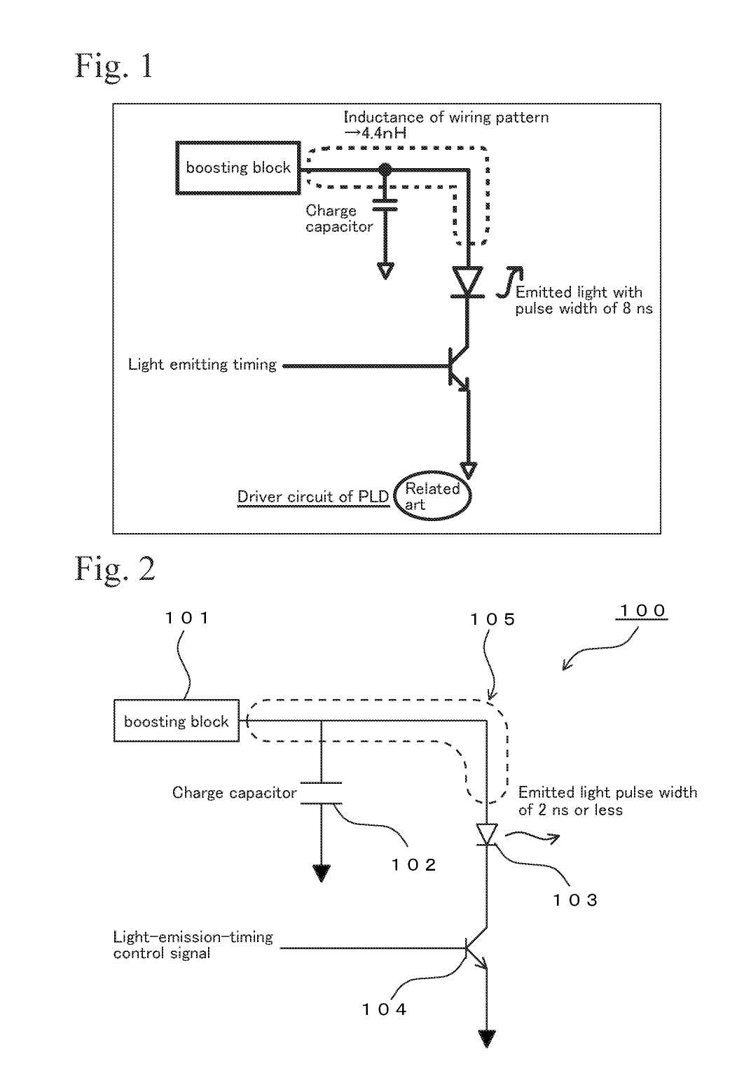

### PREFERRED EMBODIMENTS OF THE INVENTION

Structure

FIG. 2 shows a light emitting circuit 100 using the present invention. The light emitting circuit 100 includes a boosting block 101 serving as a power source, a charge capacitor 102, a laser diode 103 serving as a light emitting element, and a switching element 104. The charge capacitor 102 stores electric charges by supplying voltage from the boosting block 101. In this condition, the switching element 104 is turned on to let the electric charges, which are stored in the charge capacitor 102, instantly flow in the laser diode 103, thereby allowing the laser diode 103 to emit pulsed light.

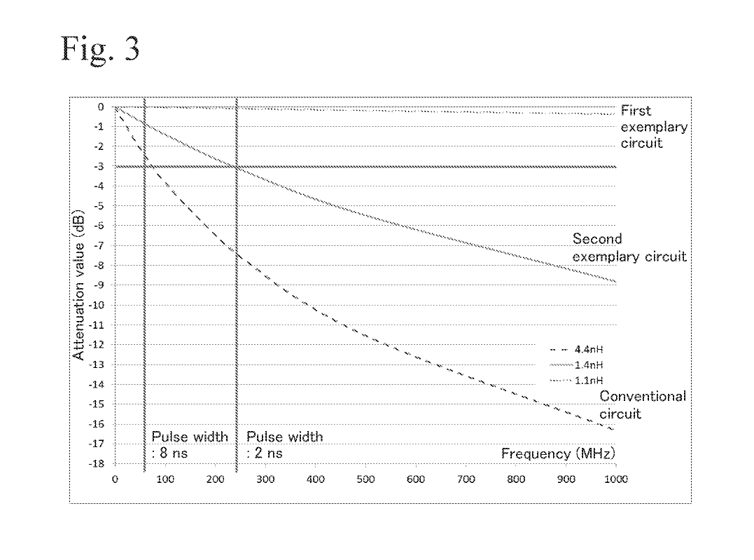

The inductance of a wiring 105 extending to the laser diode 103 greatly affects the pulse width of the emitted light. FIG. 3 shows a relationship between a frequency (corresponding to a pulse width) and an attenuation value in each wiring having a different inductance. As clearly shown in FIG. 3, setting the inductance of the wiring 105 at not greater than 1.4 nH reduces the attenuation of light with a pulse width of 2 ns to be not greater than 3 dB, thereby enabling emission of light with a pulse width of 2 ns.

Hereinafter, a specific example of making the wiring 105 having an inductance of not greater than 1.4 nH will be described. In general, an inductance component (μH) of a PCB wiring pattern is calculated by the following approximation formula. Here, the symbol “L” represents a pattern length, the symbol “W” represents a pattern width, and the symbol “H” represents a pattern thickness.

Inductance component=0.0002 L[(log(2×L)/(W+H))+0.2235((W+H)/L)+0.5](μH) First Formula

A conventional pattern typically has a length “L” of approximately 7 mm, a width “W” of approximately 1 mm, and a thickness “H” of approximately 18 μm, and the inductance of a conventional wiring corresponding to the wiring 105 is approximately 4.4 nH. In this embodiment, for example, the wiring 105 has a width “W” of 1 mm and a thickness “H” of 18 μm. To set the inductance to be not greater than 1.4 nH, the wiring 105 of this embodiment must have a length “L” of 3 mm or less.

As described above, the light emitting circuit 100 is configured to emit pulsed light and includes the boosting block 101 serving as a voltage generating circuit, the laser diode 103 serving as a light emitting element, the wiring 105, the charge capacitor 102 with its end connected to the wiring 105, and the switching element 104 configured to be turned on or off to apply the voltage to the laser diode 103. The wiring 105 has an inductance of not greater than 1.4 nH. The laser diode 103 emits pulsed light with a pulse width of 2 ns or less. Setting the inductance of the wiring 105 at not greater than 1.4 nH reduces the attenuation value of light with a pulse width of 2 ns or less to be not greater than 3 dB, thereby enabling emission of light with a pulse width of 2 ns or less.

What is claimed is:

1. A circuit configured to emit pulsed light, comprising:
a voltage generating circuit;
a light emitting element;
a circuit wiring that connects the voltage generating circuit and the light emitting element;
a charge capacitor with its end connected to the circuit wiring; and
a switching element configured to be turned on or off to apply voltage to the light emitting element,
wherein the inductance of the circuit wiring is not greater than 1.4 nH, and the light emitting element emits pulsed light with a pulse width of 2 ns or less.
